(19) United States
(12) Patent Application Publication
(10) Pub. No.: US 2014/0063836 A1
(43) Pub. Date: Mar. 6, 2014

(54) Laser Lighting Device

(71) Applicant: WALSIN LIHWA CORPORATION, Yangmei City (TW)

(72) Inventors: Chung-I Chiang, Yangmei City (TW); Min-Ching Lin, Yangmei City (TW); Ching-Huan Liao, Yangmei City (TW)

(73) Assignee: Walsin Lihwa Corporation, Yangmei City (TW)

(21) Appl. No.: 13/746,497

(22) Filed: Jan. 22, 2013

(30) Foreign Application Priority Data
Aug. 30, 2012 (TW) 101131505

(51) Int. Cl. F21V 8/00

(52) U.S. Cl. CPC G02B 6/0001
USPC 362/553

(57) ABSTRACT

A laser lighting device, including a laser light source and a light pipe, is disclosed. The laser light source can produce a laser beam with a diffusion angle not larger than 30 degrees. The light pipe is disposed in a light path of the laser beam, and has a light incident surface, a light exiting surface and several cut planes. The light incident surface is opposite to the laser light source, and the cut planes are located between the light incident and light exiting surfaces. Each of the cut planes is normal to the longitudinal direction of the light pipe, and has an area smaller than that of the light exiting surface but larger than that of the light incident surface. The areas of the cut planes increase sequentially along the longitudinal direction. The laser beam will be effectively collimated by the light pipe after passing through the light pipe.

### CROSS-REFERENCES TO RELATED APPLICATIONS

This application claims priority to Taiwan Patent Application No. 101131505 filed on Aug. 30, 2012, which is hereby incorporated herein by reference in its entirety.

### BACKGROUND OF THE INVENTION

1. Field of the Invention

The present invention provides a lighting device, and more particularly, a laser lighting device.

2. Descriptions of the Related Art

Due to the advancement of science and technology, projectors which once had a bulky volume, a heavy weight and poor portability can now be made to be pocketsize, lightweight and portable. This kind of portable projector is also known as “miniaturized projectors”.

Unlike conventional projectors that utilize non-solid-state light sources such as high pressure mercury lamps, a miniaturized projector typically projects an image by using light rays emitted by a solid-state light source (i.e., a laser diode or a light emitting diode (LED)). Furthermore, miniaturized projectors require a specific collimation degree and symmetry of the light rays of the solid-state light source; however, the collimation degree and symmetry of light rays emitted by the solid-state light source are inadequate for this, so a collimator and a beam shaper must be used to improve the collimation degree and symmetry of the light rays.

However, both the collimator and beam shaper are designed to be aspheric, which is difficult to manufacture, and adds to the overall cost of the miniaturized projector. Additionally, during the assembly process, the solid-state light source and the collimator must be aligned accurately for the light rays of the solid-state light source to be collimated effectively; and if any alignment error exists, the collimation of the light rays will be greatly affected.

In view of the aforesaid shortcomings of the collimator and the beam shaper, other devices capable of collimating or symmetrizing light rays have been proposed to replace the collimator and the beam shaper in the projector. For example, the lighting structure disclosed in Taiwan Patent Publication No. 1282480 (also published as U.S. patent Publication No. U.S. Pat. No. 7,354,178) employs a material layer with a multi-step reflecting surface to collimate light rays emitted by an LED.

However, this lighting structure is unable to make the light rays symmetric. Moreover, this lighting structure requires the LED to be located only in the material layer but not outside the material layer; otherwise, it would be impossible for light rays with a large diffusion angles that are emitted by the LED to be effectively collimated.

Accordingly, a need is existed in the art to provide a lighting device which can improve at least one of the aforesaid shortcomings

### SUMMARY OF THE INVENTION

An objective of the present invention is to provide a laser lighting device which can effectively collimate laser rays.

Another objective of the present invention is to provide another laser lighting device which can effectively make the laser rays symmetrical.

A further objective of the present invention is to provide a further laser lighting device in which a laser light source can be flexibly arranged.

To achieve at least one of the aforesaid objectives, a laser lighting device disclosed in the present invention comprises the following: a laser light source, for producing a laser beam with a diffusion angle not larger than 30 degrees; and a light pipe, disposed in an optical path of the laser beam to collimate the laser beam, wherein the light pipe has a light incident surface, a light exiting surface and a plurality of first cut planes. The light incident surface faces the laser light source, while the first cut planes are located between the light incident surface and the light exiting surface. Each of the first cut planes is normal to a longitudinal direction of the light pipe, and each of the first cut planes has an area smaller than an area of the light exiting surface and larger than an area of the light incident surface; wherein the areas of the first cut planes increase sequentially along the longitudinal direction of the light pipe.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram of a laser lighting device according to the first preferred embodiment of the present invention;

FIG. 2 is another schematic diagram of the laser lighting device of FIG. 1;

FIG. 3 is a yet another schematic diagram of the laser lighting device of FIG. 1;

FIG. 4 is a schematic diagram illustrating a laser beam traveling in the light pipe of the laser lighting device of FIG. 1;

FIG. 5 is a diagram illustrating the distribution of the light intensity of the laser beam after passing through the light pipe of FIG. 1;

FIG. 6 is a diagram illustrating the optical coupling efficiency between the laser light source and the light pipe of FIG. 1 versus the spacing therebetween;

FIG. 7A is a schematic diagram illustrating the shape of a light exiting surface of the light pipe of FIG. 1;

FIG. 7B is a schematic diagram illustrating another shape of the light exiting surface of the light pipe of FIG. 1;

FIG. 7C is a schematic diagram illustrating another shape of the light exiting surface of the light pipe of FIG. 1;

FIG. 7D is a schematic diagram illustrating yet another shape of the light exiting surface of the light pipe of FIG. 1;

FIG. 8 is a schematic diagram of a laser lighting device according to the second preferred embodiment of the present invention;

FIG. 9 is a diagram illustrating the distribution of light intensity of the laser beam after passing through the light pipe of FIG. 8;

FIG. 10 is a schematic diagram of a laser lighting device according to the third preferred embodiment of the present invention;

FIG. 11 is another schematic diagram of the laser lighting device according to the third preferred embodiment of the present invention;

FIG. 12 is a schematic diagram of a laser lighting device according to the fourth preferred embodiment of the present invention;

FIG. 13 is another schematic diagram of the laser lighting device according to the fourth preferred embodiment of the present invention;

FIG. 14A is a diagram illustrating the distribution of light intensity of the laser beam before passing through the light pipe of the present invention;

FIG. 14B is a diagram illustrating the distribution of light intensity of the laser beam after passing through the light pipe of the present invention;

FIG. 15A is a diagram illustrating the distribution of light intensity of a light beam produced by a conventional light emitting diode (LED) before passing through the light pipe of the present invention; and

FIG. 15B is a diagram illustrating the distribution of light intensity of the light beam produced by the conventional LED after passing through the light pipe of the present invention.

### DESCRIPTION OF THE PREFERRED EMBODIMENT

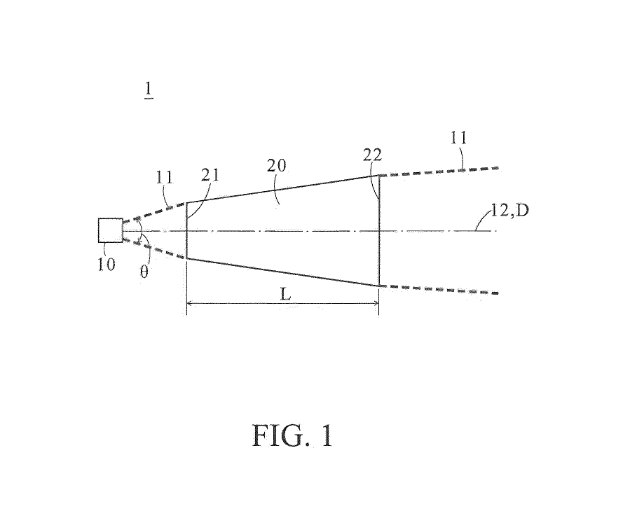

Referring to FIG. 1, it is a schematic diagram of a laser lighting device according to the first preferred embodiment of the present invention. The laser lighting device 1 at least comprises a laser light source 10 and a light pipe 20, and the technical contents and operations thereof will be described as below.

The laser light source 10 may be a laser diode and is adapted to produce a laser beam 11. The laser beam 11 has an initial diffusion angle θ not larger than 30 degrees. In other words, the diffusion angle θ can have a maximum value of 30 degrees. In this embodiment, the laser beam 11 has a diffusion angle θ of about 18 degrees. The laser beam 11 further has an optical path 12 along which the laser beam 11 travels. The optical path 12 is normal to the light exiting surface of the laser light source 10.

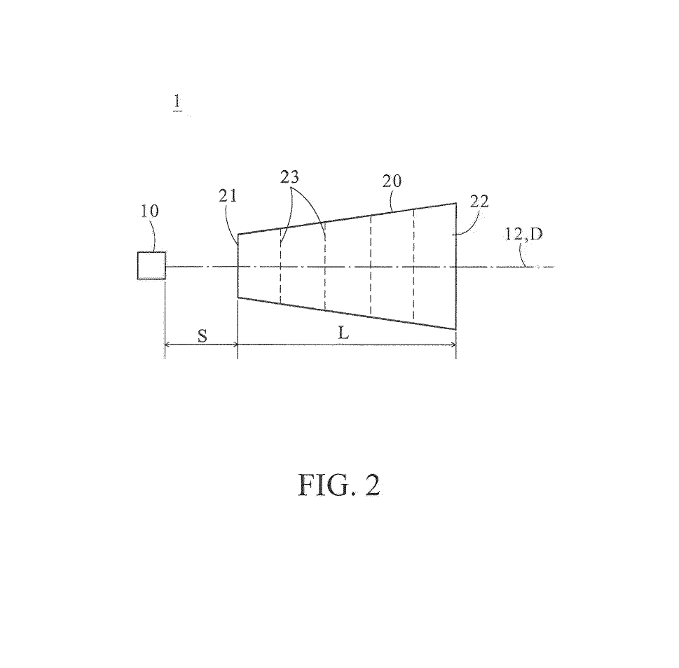

The light pipe 20 is disposed in the optical path 12 of the laser beam 11 to allow the laser beam 11 to propagate into the light pipe 20; in other words, the light pipe 20 and the laser light source 10 are optically coupled to each other. Furthermore, in this embodiment, the light pipe 20 may be disposed apart in front of the laser light source 10; in other words, the laser light source 10 does not come into contact with the light pipe 20 but maintains a spacing S therefrom (as shown in FIG. 2).

The light pipe 20 may be a solid structure having a refractive index of no less than 1.4 to facilitate the laser beam 11 traveling in the light pipe 20 through total internal reflection. To have a refractive index of no less than 1.4, the light pipe 20 may be made of polymethylmethacrylate (PMMA), polycarbonates (PC), highly refractive glass (BK7) or glass.

The light pipe 20 is further defined with a length L and a longitudinal direction D. The relationship between the length L and the longitudinal direction D is such that the two ends of the light pipe 20 define a distance therebetween in a specific direction. The specific direction is the longitudinal direction D, while the distance value is the length L. In this embodiment, the longitudinal direction D may be parallel to or overlap with the optical path 12.

FIG. 2 is another schematic diagram of the laser lighting device of FIG. 1, which illustrates the first cut planes of the light pipe. The light pipe 20 has a light incident surface 21, a light exiting surface 22 and a plurality of first cut planes 23. The light incident surface 21 of the light pipe 20 is opposite the laser light source 10 (i.e., face to face). The laser beam 11 propagates into the light pipe 20 through the light incident surface 21 as shown in FIG. 1. The light exiting surface 22 is located at the other side of the light pipe 20, while the laser beam 11 exits from the light pipe 20 through the light exiting surface 22.

The first cut planes 23 are located between the light incident surface 21 and the light exiting surface 22, with each of the first cut planes 23 being normal to the longitudinal direction D of the light pipe 20. It should be appreciated that because the first cut planes 23 as a whole can not be seen directly from the outside of the light pipe 20, only the side lines of the first cut planes 23 are illustrated in FIG. 2. The first cut planes 23 as a whole can only be seen by cutting the light pipe 20 along a direction that is normal to the longitudinal direction D.

Each of the first cut planes 23 has an area smaller than that of the light exiting surface 22 but larger than that of the light incident surface 21. Moreover, the areas of the first cut planes 23 increase sequentially along the longitudinal direction D of the light pipe 20 (i.e., along the optical path 12). Accordingly, the first cut planes 23 closer to the light incident surface 21 have a smaller area which is at least larger than the area of the light incident surface 21. The first cut planes 23 farther away from the light incident surface 21 have a larger area which is at least smaller than the area of the light exiting surface 22.

It can be known that the light pipe 20 is a frustum in view of the relationship between the areas of the light incident surface 21, the light exiting surface 22 and the first cut planes 23.

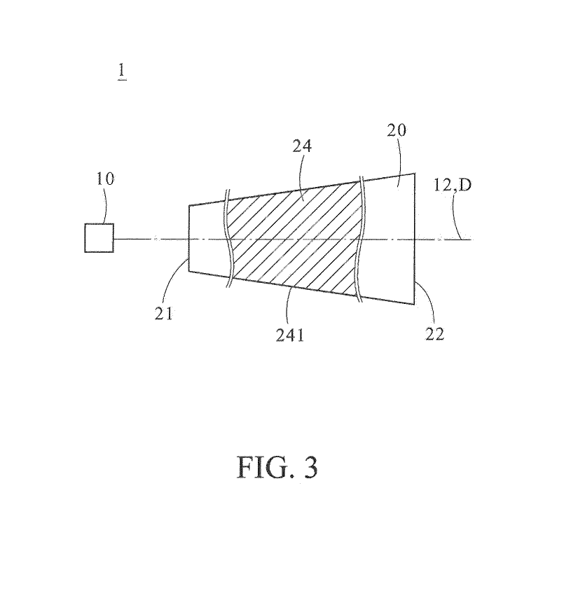

FIG. 3 is a further schematic diagram of the laser lighting device of FIG. 1, which illustrates a second cut plane of the light pipe. The light pipe 20 further has a second cut plane 24, which is also located between the light incident surface 21 and the light exiting surface 22 and normal to each of the first cut planes 23. Like the first cut planes 23, the second cut plane 24 as a whole can not be seen directly from the outside of the light pipe 20 (as shown in FIG. 1), but can only be seen by cutting the light pipe 20 along a direction that is normal to the longitudinal direction D. The second cut plane 24 has a side line 241 which, in this embodiment, may be a straight side line.

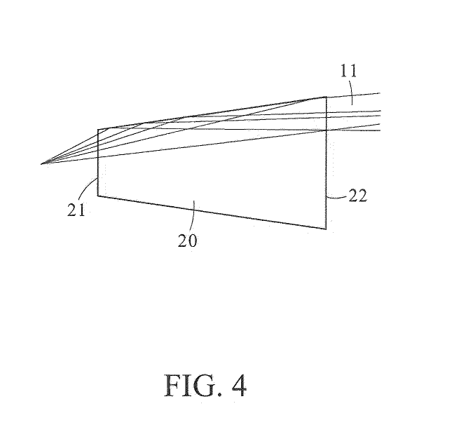

FIG. 4 is a schematic diagram illustrating the laser beam traveling in the light pipe of the laser lighting device of FIG. 1. The light pipe 20 can be used to collimate the laser beam 11 so that the laser beam 11 will have a smaller diffusion angle after passing through the light pipe 20. In detail, after the laser beam 11 propagates into the light pipe 20, portions of the laser beam 11 having large angles will impinge on the outer surface of the light pipe 20 and then be internally reflected within the light pipe 20. The angle between the laser beam 11 and the optical path 12 will become smaller through the reflection, thereby achieving the purpose of collimation.

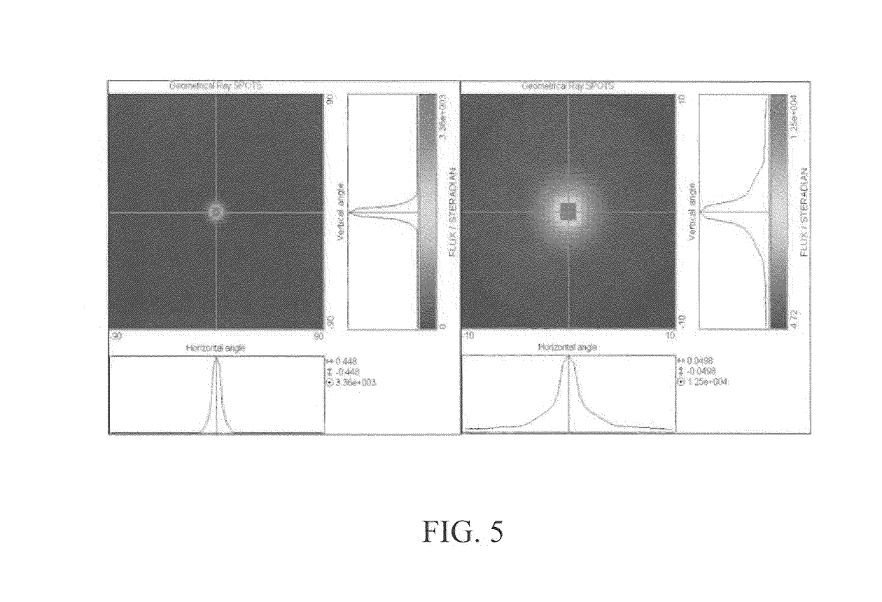

With reference to both FIGS. 5 and 2 together, FIG. 5 is a diagram illustrating the distribution of light intensity of the laser beam after passing through the light pipe of the laser lighting device of FIG. 1. In the case where the diameters of the light incident surface 21 and the light exiting surface 22 of the light pipe 20 are 0.5 millimeters and 1.45 millimeters respectively, the length L of the light pipe 20 is 4 millimeters, and the spacing S between the light pipe 20 and the laser light source 10 is 0.1 millimeters. The light intensity of the laser beam 11 (as shown in FIG. 1) after passing through the light pipe 20 becomes very concentrated, and the diffusion angle of the laser beam 11 is changed from 18 degrees into 3 degrees.

Thus, the laser lighting device 1 of this embodiment can provide a more collimated laser beam 11, so the laser lighting device 1 can be advantageously used in devices such as miniaturized projectors.

With reference to FIGS. 1 and 2, it is worth noting that the spacing S between the light pipe 20 and the laser light source 10 can be determined by the diffusion angle θ and the area of the light incident surface 21. That is, for a large diffusion angle θ, the spacing S can be shortened or the area of the light incident surface 21 can be increased.

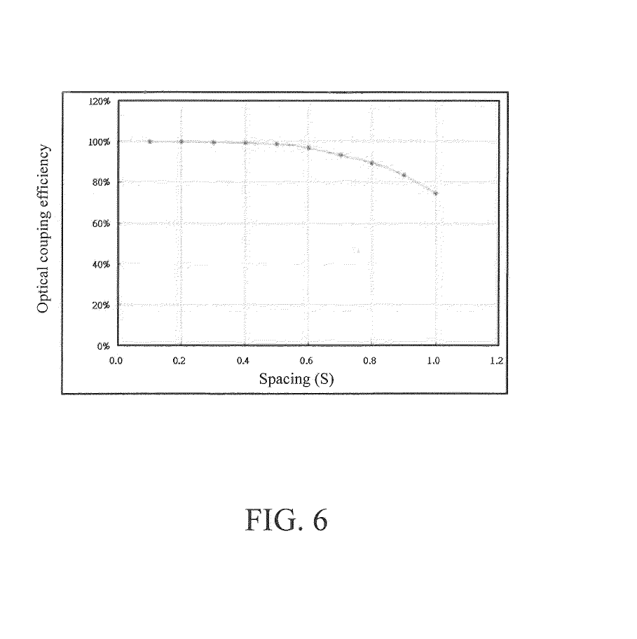

FIG. 6 illustrates a diagram of the optical coupling efficiency versus the spacing of the laser lighting device of FIG. 1. When the spacing S is determined by the diffusion angle θ and the area of the light incident surface 21, the optical coupling efficiency between the laser light source 10 and the light pipe 20 will be better. For example, if the initial diffusion angle θ is 18 degrees, a spacing S within 0.5 millimeters can result in a good optical coupling efficiency. In this way, the position of the laser light source 10 relative to the light pipe 20 can be flexibly arranged by the user as desired under the limitation of the spacing S of 0.5 (which may be other numerical values in other embodiments).

It is also worth noting that “the spacing S between the light pipe 20 and the laser light source 10” and “the length L of the light pipe 20” can be maintained as fixed values; and preferably, “the spacing S between the light pipe 20 and the laser light source 10” is smaller than “the length L of the light pipe 20”.

For example, when the sum of the spacing S and the length L is fixed to 4.5 millimeters, the combinations of the spacing S and the length L may be any of the following combinations: a spacing S of 0.5 millimeters and a length L of 4 millimeters; a spacing S of 0.3 millimeters and a length L of 4.2 millimeters; a spacing S of 0.1 millimeters and a length L of 4.4 millimeters. The laser beam 11 can be collimated effectively by the light pipe 20 no matter which of the combinations is adopted.

It is also worth noting that the light incident surface 21 of the light pipe 20 may be a flat surface instead of a curved surface. In this case, the alignment tolerance between the laser light source 10 and the light pipe 20 during the assembly process may be large, but the laser beam 11 produced by the laser light source 10 is still collimated by the light pipe 20. The light exiting surface 22 may be a flat surface or a curved surface; and when the light exiting surface 22 is a curved surface, the collimating capability of the light pipe 20 can be further improved.

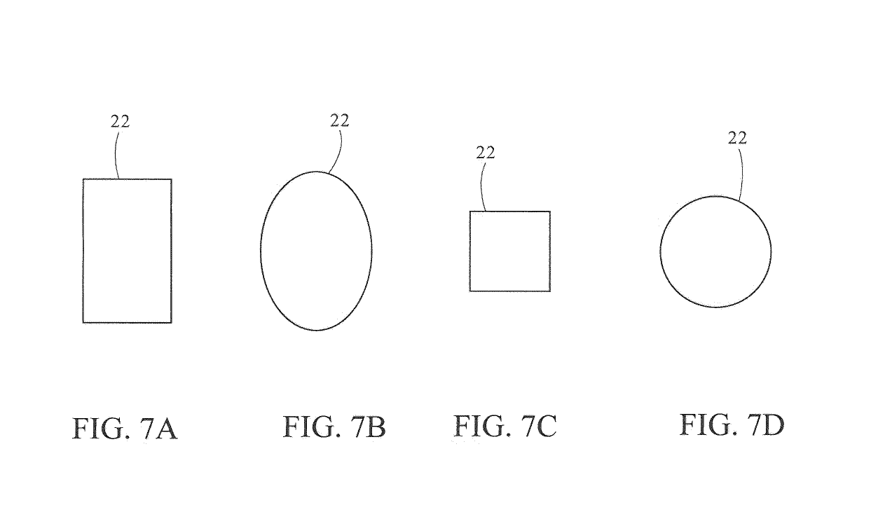

In case of a flat surface, the light exiting surface 22 may further be a flat surface of an asymmetrical shape (e.g., a rectangular shape or an elliptic shape shown in FIGS. 7A and 7B) or a flat surface of a symmetrical shape (e.g., a square shape or a circular shape shown in FIGS. 7C and 7D). The light exiting surface 22 of an asymmetrical shape can provide the light pipe 20 with a further capability of making the laser beam 11 symmetrical so that after the laser beam 11 passes through the light pipe 20 at asymmetrical diffusion angles, the diffusion angles of the laser beam 11 will become relatively uniform in various directions.

The first preferred embodiment of the present invention has been described above. Next, the laser lighting devices according to other preferred embodiments of the present invention will be described. For purpose of simplicity, similarities between the other preferred embodiments and the first preferred embodiment and between the other preferred embodiments will be omitted from description.

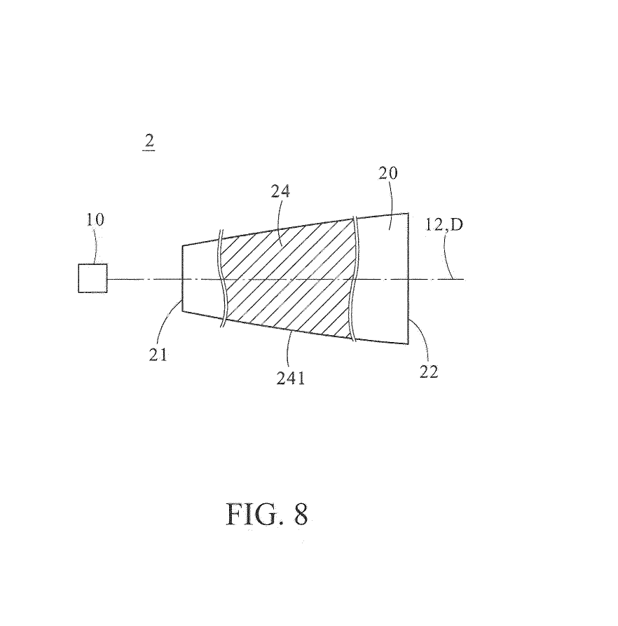

FIG. 8 is a schematic diagram of a laser lighting device according to the second preferred embodiment of the present invention, which illustrates the second cut plane of the light pipe. The laser lighting device 2 of the second preferred embodiment is different from the laser lighting device 1 of the first preferred embodiment in that the second cut plane 24 of the light pipe 20 of the laser lighting device 2 has a curved side line 241; i.e., the side line 241 is non-straight.

The curved side line 241 can be defined by an aspheric equation of

$$sag ( ρ ) = \frac{{ρ}^{2} / r}{\sqrt{1 - ( 1 + {c ( ρ / r )}^{2} )}} ,$$

in which c is a conic constant and r is a radius from the optic axis.

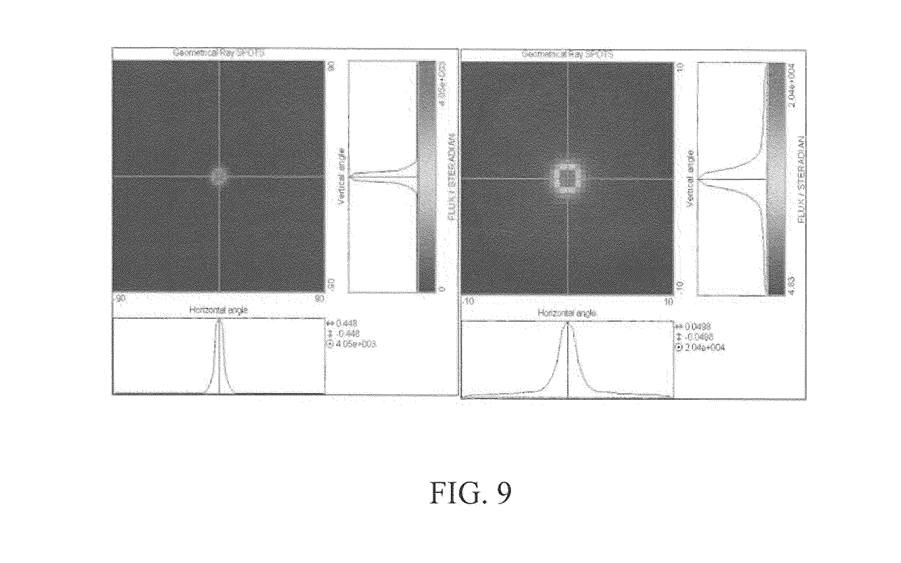

FIG. 9 illustrates the distribution of light intensity of the laser beam after passing through the light pipe of the laser lighting device of FIG. 8. After the laser beam 11 passes through the light pipe 20 having a curved side line 241, the light intensity of the laser beam 11 becomes more concentrated as compared with the distribution of light intensity shown in FIG. 5; in other words, the curved side line 241 can provide the light pipe 20 with a better collimation capability.

It should be noted that the distribution graphs of the light intensity of FIG. 9 are obtained from the following parameters: the diameter of the light incident surface 21 of the light pipe 20 is 0.5 millimeters, the diameter of the light exiting surface 22 is 1.36 millimeters, the length L of the light pipe 20 is 4 millimeters, the spacing S between the light pipe 20 and the laser light source 10 is 0.1 millimeters, the conic constant (c) is 1.008, and the radius (r) is 0.025 millimeters.

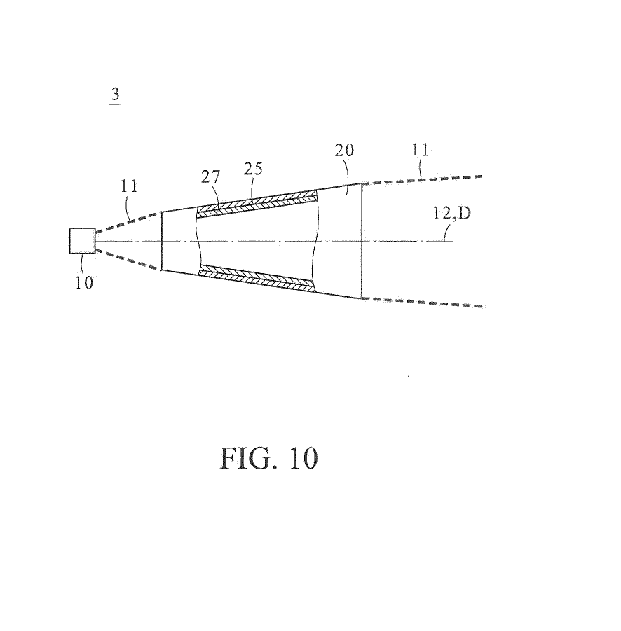

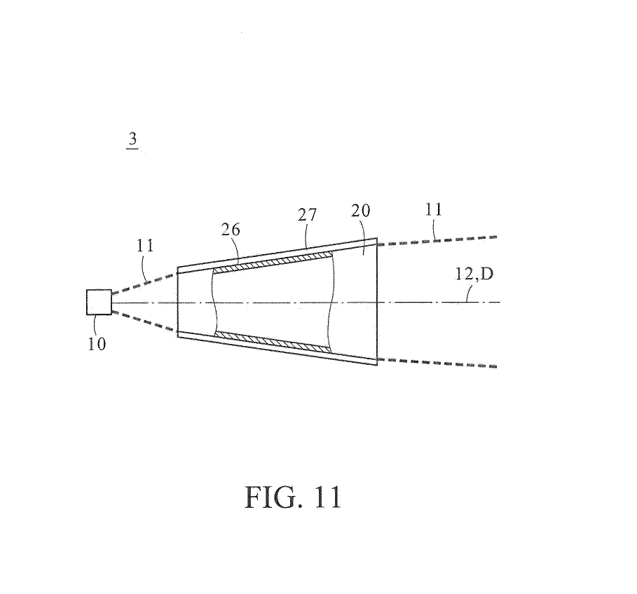

FIGS. 10 and 11 show two schematic diagrams of a laser lighting device according to the third preferred embodiment of the present invention. The laser lighting device 3 of the third preferred embodiment is different from the laser lighting devices 1 and 2 in that the light pipe 20 of the laser lighting device 3 is of a hollow structure, and a reflective layer 27 is disposed on the inner surface 25 (as shown in FIG. 10) or the outer surface 26 (as shown in FIG. 11) of the light pipe 20.

When the laser beam 11 propagates into the hollow light pipe 20 of the third preferred embodiment, portions of the laser beam 11 having large angles will impinge on the reflective layer 27 of the light pipe 20 and be reflected by the reflective layer 27; and the angle between the laser beam 11 and the optical path 12 will become smaller through the reflection, thus, achieving the purpose of collimation. It should be noted that the reflective layer 27 preferably has a reflectance of no less than 90%, so that only a small portion of the laser beam 11 impinging on the reflective layer 27 will be absorbed by the reflective layer 27 while the remaining portions are reflected by the reflective layer 27.

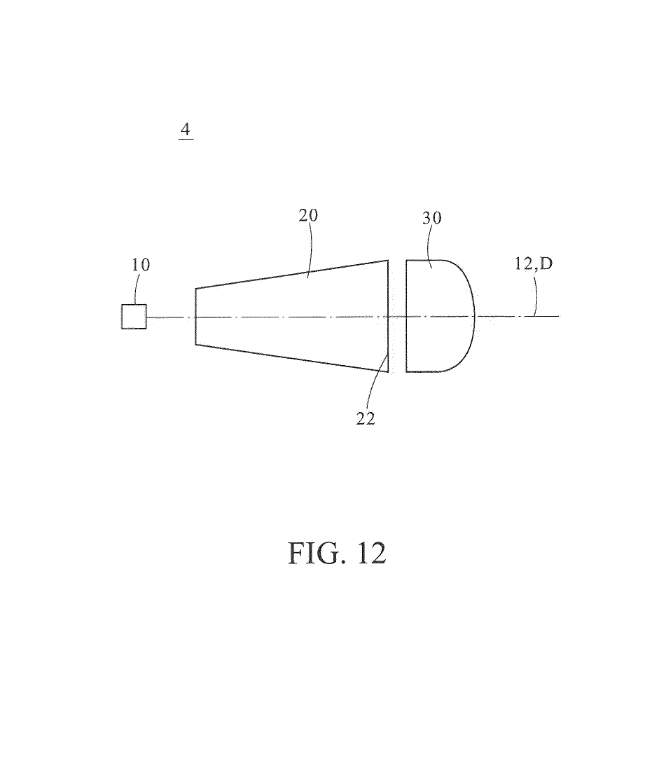

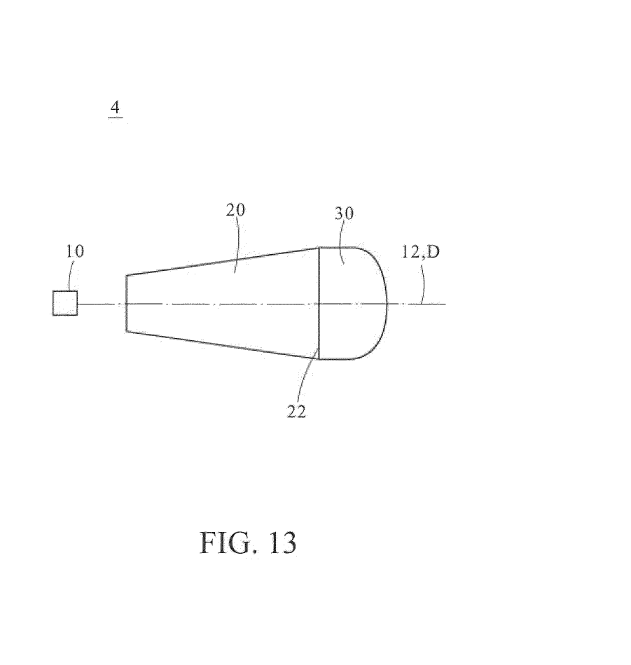

FIGS. 12 and 13 are two schematic diagrams of a laser lighting device according to the fourth preferred embodiment of the present invention. The laser lighting device 4 of the fourth preferred embodiment is different from the laser lighting devices 1, 2 and 3 in that the laser lighting device 4 further comprises an optical lens 30 disposed in front of the light exiting surface 22 of the light pipe 20. Furthermore, the optical lens 30 may come into contact with the light exiting surface 22 as shown in FIG. 11 or be disposed apart in front of the light exiting surface 22 as shown in FIG. 12. The collimated laser beam (not shown) that exits from the light pipe 20 can be further collimated by the optical lens 30.

Here, it should be further noted that according to the Etendue theory, the product of the area of the light incident surface and the diffusion angle of the light source is equal to the product of the area of the light exiting surface and the diffusion angle of the exiting light, and the area is proportional to the radius if the light incident surface or the light exiting surface is circular. Therefore, if the output light rays are to be collimated (i.e., to make the diffusion angle of the exiting light close to zero), then the larger the divergence angle of the light source, the smaller the area of the light incident surface of the light pipe or the larger the area of the light exiting surface will need to be.

However, in consideration of the gap between the light source and the light pipe, too small of area of the light incident surface would lead to a decreased optical coupling efficiency of the incident light. Therefore, when the diffusion angle of the light source becomes larger, the area of the light exiting surface of the light pipe must be increased to make it possible for the light to be collimated.

The diffusion angle of the conventional light emitting diode (LED) is about 120 degrees which is significantly different from the diffusion angle of the laser light source (i.e., LD) of this application that is less than 30 degrees.

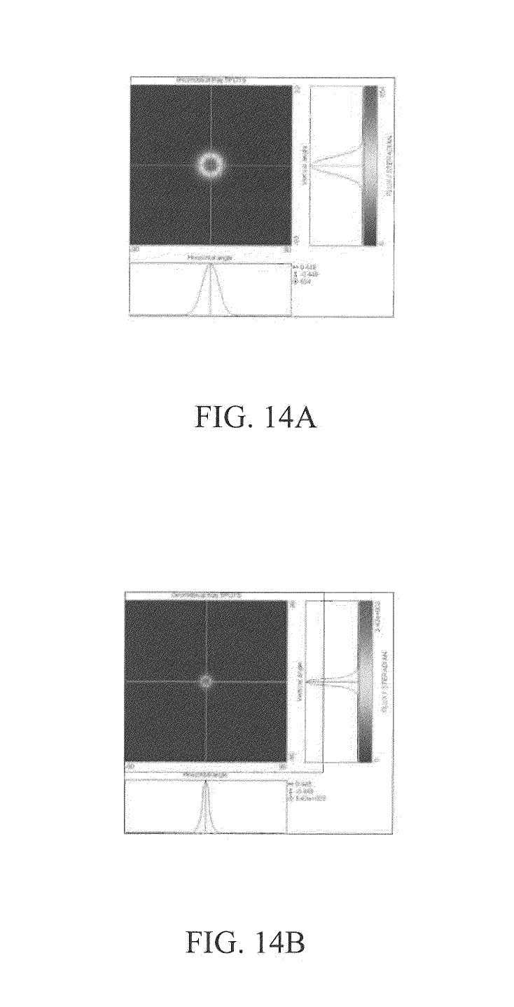

FIGS. 14A and 14B show diagrams illustrating the distributions of light intensity of the laser beam before and after passing through the light pipe of the present invention respectively. As can be seen, the initial diffusion angle of the laser beam is 20 degrees, and the laser beam can be well collimated after passing through the light pipe.

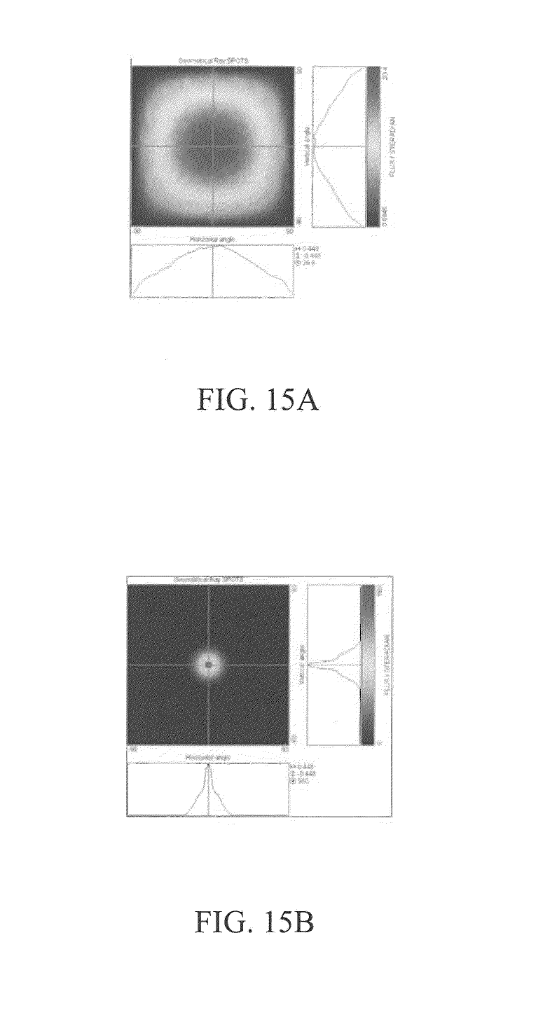

FIGS. 15A and 15B show diagrams illustrating the distributions of light intensity of the light beam produced by the LED before and after passing through the light pipe of the present invention respectively. As can be seen, when the light pipe disclosed in the present invention is used in conjunction with the conventional LED, the light collimating effect is very poor; in other words, the light beam produced by the LED still has an obvious diffusion angle and is not collimated after passing through the light pipe.

As can be known from the aforesaid Etendue theory, the area of the light exiting surface of the light pipe must be increased to obtain the same light collimating effect. Therefore, using the LED having a diffusion angle of 120 degrees shown herein as an example, the area of the light exiting surface of the light pipe used in conjunction with the LED should be quadruple that of the light pipe of the present invention, making it very bulky and uneconomical.

In the lighting structure disclosed in Taiwan Patent Publication No. 1282480 (also published as U.S. patent Publication No. U.S. Pat. No. 7,354,178), the LED thereof cannot be replaced directly with a laser diode in practice. The reason is that to collect all the light rays emitted by the LED in the conventional lighting structure, the volume of the light pipe is certainly made much greater than that of the present invention to ensure the optical characteristics of the LED. Consequently, even if the LED in the conventional structure is directly replaced with the laser diode, there is still no interaction between most of the multi-step reflecting surface of the material layer in the conventional lighting structure and the laser rays. In summary, the LED in the conventional lighting structure cannot be directly replaced with the laser diode, or those of ordinary skill in the art cannot use a common conventional LED directly in conjunction with the light pipe of the present invention to achieve the light collimating effect.

According to the above descriptions, the laser lighting device of the present invention can overcome the shortcomings of the prior art to provide a laser beam that has a relatively small diffusion angle or a laser beam that is relatively symmetrical. Moreover, the spacing between the laser light source and the light pipe of the laser lighting device can be adjusted, so the laser light source can be arranged flexibly. In addition, since the spacing between the laser light source and the light pipe can be determined by the diffusion angle and the area of the light incident surface, a desirable optical coupling efficiency can be obtained between the laser light source and the light pipe most portion of the light pipe is exposed to impinging of the laser rays to serve the function of collimating the light rays, thereby achieving the purpose of making full use of the light pipe.

The above disclosure is related to the detailed technical contents and inventive features thereof. People skilled in this field may proceed with a variety of modifications and replacements based on the disclosures and suggestions of the present invention as described without departing from the characteristics thereof. Nevertheless, although such modifications and replacements are not fully disclosed in the above descriptions, they have substantially been covered in the following claims as appended.

What is claimed is:

1. A laser lighting device, comprising:
a laser light source, for producing a laser beam with a diffusion angle not larger than 30 degrees; and
a light pipe, disposed in an optical path of the laser beam to collimate the laser beam, wherein the light pipe has a light incident surface, a light exiting surface and a plurality of first cut planes, the light incident surface faces the laser light source, the first cut planes are located between the light incident surface and the light exiting surface, each of the first cut planes is normal to a longitudinal direction of the light pipe, and each of the first cut planes has an area smaller than an area of the light exiting surface and larger than an area of the light incident surface;
wherein the areas of the first cut planes increase sequentially along the longitudinal direction of the light pipe.

2. The device of claim 1, wherein an interval between the light pipe and the laser light source is smaller than a length of the light pipe.

3. The device of claim 2, wherein the length of the light pipe is larger than zero and less than 4.5 millimeter.

4. The device of claim 1, wherein an interval between the light pipe and the laser light source is defined by the diffusion angle and the area of the light incident surface.

5. The device of claim 4, wherein the interval is larger than zero and not larger than 0.5 millimeter.

6. The device of claim 1, wherein the light pipe further has a second cut plane, the second cut plane is located between the light incident surface and the light exiting surface and is normal to the first cut planes, and the second cut plane has a straight side line.

7. The device of claim 1, wherein the light pipe further has a second cut plane, the second cut plane is located between the light incident surface and the light exiting surface and is normal to the first cut planes, and the second cut plane has a curved side line.

8. The device of claim 7, wherein the curved side line is defined by an aspheric equation.

9. The device of claim 1, wherein the light incident surface is a flat surface.

10. The device of claim 1, wherein the light exiting surface is a flat surface or a curved surface.

11. The device of claim 1, wherein the light exiting surface is a flat surface of an asymmetrical shape.

12. The device of claim 11, wherein the light exiting surface is rectangular or elliptic.

13. The device of claim 1, wherein the light exiting surface is a flat surface of a symmetrical shape.

14. The device of claim 13, wherein the light exiting surface is square or circular.

15. The device of claim 1, wherein the light pipe is a solid structure.

16. The device of claim 15, wherein the light pipe has a refractive index of no less than 1.4.

17. The device of claim 1, wherein the light pipe is a hollow structure, and a reflective layer is disposed on an inner surface or an outer surface of the light pipe.

18. The device of claim 17, wherein the reflective layer has a reflectance of no less than 90%.
